(19) United States
(12) Patent Application Publication
(10) Pub. No.: US 2011/0104448 A1
(43) Pub. Date: May 5, 2011

(54) UNILATERAL SWEAT-ABSORBING QUICK-DRYING COMFORTABLE FABRIC AND METHOD FOR PREPARING THE SAME

(75) Inventors: HSING NAN CHUNG, YUNLIN COUNTY (TW); YOUNG CHIN CHEN, YUNLIN COUNTY (TW); SHIN MEI LIN, YUNLIN COUNTY (TW)

(73) Assignee: FORMOSA TAFFETA CO., LTD., TOULIU (TW)

(21) Appl. No.: 12/911,058

(22) Filed: Oct. 25, 2010

(30) Foreign Application Priority Data
Oct. 29, 2009 (TW) 098136613

(51) Int. Cl. B32B 3/10; D04H 3/04

(52) U.S. Cl. 428/172; 28/100; 428/195.1

(57) ABSTRACT

A unilateral sweat-absorbing quick-drying fabric includes a hydrophilic base having an inner surface and an outer surface and a plurality of hydrophobic patterns embedded in the inner surface, wherein the hydrophilic base includes fiber material, and the hydrophobic patterns are configured to transfer sweat absorbed by the hydrophilic base from the inner surface to the outer surface by unilateral capillary action. A method for preparing the unilateral sweat-absorbing quick-drying fabric is characterized by embedding a plurality of hydrophobic patterns in an inner surface of a hydrophilic base including fiber material, wherein the hydrophobic patterns are configured to transfer sweat absorbed by the hydrophilic base from the inner surface to an outer surface of the hydrophilic base by unilateral capillary action.

### BACKGROUND OF THE INVENTION

1. Technical Field

The present invention relates to a quick-drying fabric and method for preparing the same, and more particularly, to a unilateral sweat-absorbing quick-drying comfortable fabric and method for preparing the same.

2. Background

With the rise of living standards in recent years, people are demanding more from clothing fabrics regarding comfort properties such as sweat absorbance, quick drying ability, and lack of adherance to the skin of the user. Since the skin of the user is relatively smooth, clothing fabric adheres to the skin of the user as the clothing fabric absorbs the sweat or moisture from the skin, but the adhesion of the fabric with absorbed sweat or moisture causes discomfort.

To solve this discomfort, the conventional technique forms grooves or protrusions on the fabric to implement the sweat-absorbing and quick-drying functions; however, the grooves or protrusions cause an uncomfortably rough feeling, the fabrication process is relatively complex, and the fabric is relatively heavy, which limit its application. Another conventional technique uses multi-layer functional fabrics to implement the sweat-absorbing and quick-drying functions; however, the fabrication process is relatively complex, and the fabric is relatively heavy, which limit its application

### SUMMARY

One aspect of the present invention provides a unilateral sweat-absorbing quick-drying fabric and method for preparing the same.

A unilateral sweat-absorbing quick-drying fabric according to this aspect of the present invention comprises a hydrophilic base having an inner surface and an outer surface and a plurality of hydrophobic patterns embedded in the inner surface, wherein the hydrophilic base includes fiber material, and the hydrophobic patterns are configured to transfer sweat absorbed by the hydrophilic base from the inner surface to the outer surface by unilateral capillary action.

A method for preparing a unilateral sweat-absorbing quick-drying fabric according to this aspect of the present invention is characterized in that a plurality of hydrophobic patterns are embedded in an inner surface of a hydrophilic base including fiber material, wherein the hydrophobic patterns are configured to transfer sweat absorbed by the hydrophilic base from the inner surface to an outer surface of the hydrophilic base by unilateral capillary action.

The foregoing has outlined rather broadly the features and technical advantages of the present invention in order that the detailed description of the invention that follows may be better understood. Additional features and advantages of the invention will be described hereinafter, and form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention are illustrated with the following description and upon reference to the accompanying drawings in which:

FIG. 1 is a sectional view of a unilateral sweat-absorbing quick-drying fabric according to one embodiment of the present invention;

FIG. 2 is a top view of the unilateral sweat-absorbing quick-drying fabric according to one embodiment of the present invention;

FIG. 3 is a top view of a unilateral sweat-absorbing quick-drying fabric according to another embodiment of the present invention; and

FIG. 4 is a top view of a unilateral sweat-absorbing quick-drying fabric according to another embodiment of the present invention.

### DETAILED DESCRIPTION

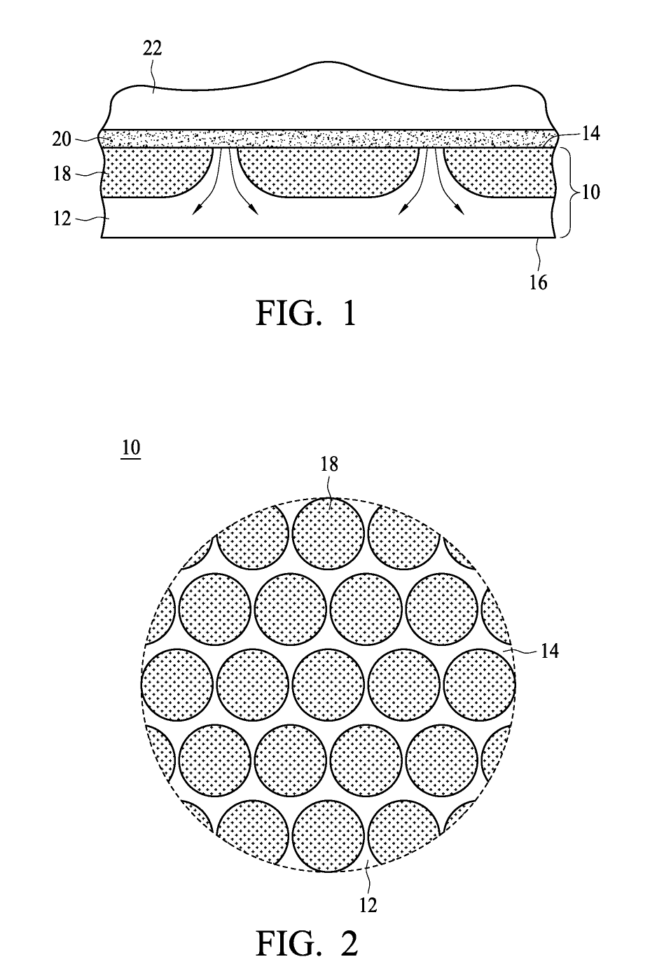

FIG. 1 is a sectional view of a unilateral sweat-absorbing quick-drying fabric 10 according to one embodiment of the present invention. FIG. 2 is a top view of the unilateral sweat-absorbing quick-drying fabric 10 according to one embodiment of the present invention. In one embodiment of the present invention, the unilateral sweat-absorbing quick-drying fabric 10 comprises a hydrophilic base 12 and a plurality of hydrophobic patterns 18, the hydrophilic base 12 has an inner surface 14 and an outer surface 16, and the hydrophobic patterns 18 are embedded in the inner surface 14. When the inner surface 14 contacts the skin 22 of a user, the hydrophobic patterns 18 enable the hydrophilic base 12 to absorb the sweat 20 by unilateral capillary action and transfer the absorbed sweat from the inner surface 14 to the outer surface 16 of the hydrophilic base 12, as shown by the arrow in FIG. 1.

In one embodiment of the present invention, the hydrophilic base 12 includes fiber material such as nylon fiber, polyester fiber, aromatic aromide fiber, rayon fiber, bamboo fiber, polylactic acid fiber, or tencel fiber. In one embodiment of the present invention, the hydrophobic patterns 18 include material selected from the group consisting of fluorocarbon, hydrocarbon, silicone, and hydrophobic polymer, and can be formed in the inner surface 14 in a matrix manner by hot stamping technique. In one embodiment of the present invention, the hydrophobic patterns 18 occupy 10% to 90% of the inner surface 14. In one embodiment of the present invention, the hydrophobic patterns 18 occupy 60% to 90% of the inner surface 14 or 20% to 60% of the inner surface 14.

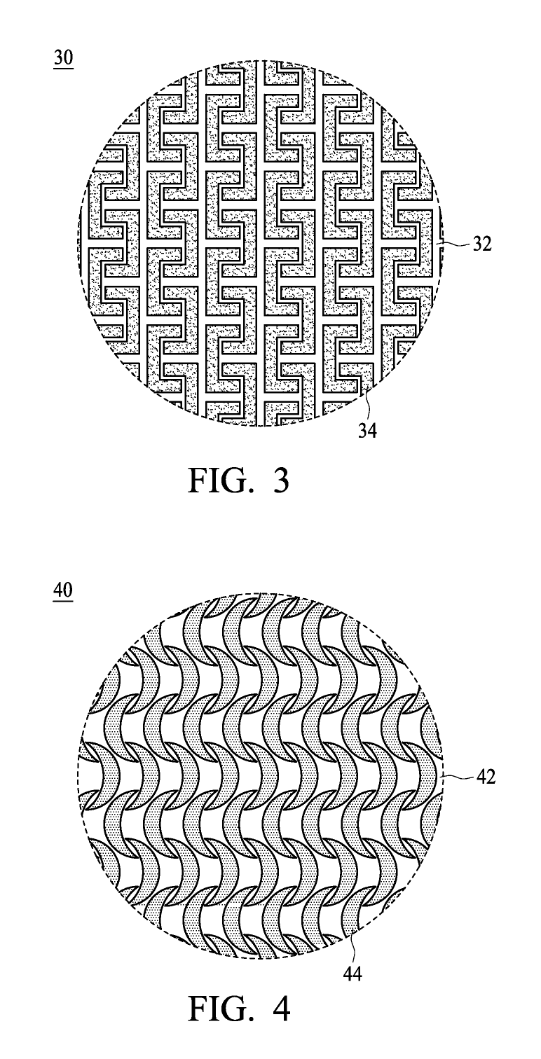

FIG. 3 is a top view of a unilateral sweat-absorbing quick-drying fabric 30 according to another embodiment of the present invention. The unilateral sweat-absorbing quick-drying fabric 10 in FIG. 1 uses the circular hydrophobic patterns 18 embedded in the hydrophilic base 12 in the matrix manner; in contrast, the unilateral sweat-absorbing quick-drying fabric 30 in FIG. 3 includes concave hydrophobic patterns 34 embedded in the hydrophilic base 32 in an interlocking manner.

FIG. 4 is a top view of a unilateral sweat-absorbing quick-drying fabric 40 according to another embodiment of the present invention. The unilateral sweat-absorbing quick-drying fabric 10 in FIG. 1 uses the circular hydrophobic patterns 18 embedded in the hydrophilic base 12 in the matrix manner; in contrast, the unilateral sweat-absorbing quick-drying fabric 40 in FIG. 4 includes crescent hydrophobic patterns 44 embedded in the hydrophilic base 42 in an interlocking manner.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A unilateral sweat-absorbing quick-drying fabric, comprising:
a hydrophilic base having an inner surface and an outer surface, with the hydrophilic base including fiber material; and
a plurality of hydrophobic patterns embedded in the inner surface, wherein the hydrophobic patterns are configured to transfer sweat absorbed by the hydrophilic base from the inner surface to the outer surface by unilateral capillary action.

2. The unilateral sweat-absorbing quick-drying fabric of claim 1, wherein the hydrophobic patterns are crescent-shaped.

3. The unilateral sweat-absorbing quick-drying fabric of claim 1, wherein the hydrophobic patterns are concave.

4. The unilateral sweat-absorbing quick-drying fabric of claim 1, wherein the hydrophobic patterns are arranged in an interlocking manner.

5. The unilateral sweat-absorbing quick-drying fabric of claim 1, wherein the hydrophobic patterns are arranged in a matrix manner.

6. The unilateral sweat-absorbing quick-drying fabric of claim 1, wherein the hydrophobic patterns occupy 10% to 90% of the inner surface.

7. The unilateral sweat-absorbing quick-drying fabric of claim 1, wherein the hydrophobic patterns occupy 60% to 90% of the inner surface.

8. The unilateral sweat-absorbing quick-drying fabric of claim 1, wherein the hydrophobic patterns occupy 20% to 60% of the inner surface.

9. The unilateral sweat-absorbing quick-drying fabric of claim 1, wherein the hydrophobic patterns include material selected from the group consisting of fluorocarbon, hydrocarbon, silicone, and hydrophobic polymer.

10. The unilateral sweat-absorbing quick-drying fabric of claim 1, wherein the fiber material is nylon fiber, polyester fiber, aromatic aromide fiber, rayon fiber, bamboo fiber, polylactic acid fiber, or tencel fiber.

11. A method for preparing a unilateral sweat-absorbing quick-drying fabric, characterized in that a plurality of hydrophobic patterns are embedded in an inner surface of a hydrophilic base including fiber material, wherein the hydrophobic patterns are configured to transfer sweat absorbed by the hydrophilic base from the inner surface to an outer surface of the hydrophilic base by unilateral capillary action.

12. The method for preparing a unilateral sweat-absorbing quick-drying fabric of claim 11, wherein the hydrophobic patterns are crescent-shaped.

13. The method for preparing a unilateral sweat-absorbing quick-drying fabric of claim 11, wherein the hydrophobic patterns are concave.

14. The method for preparing a unilateral sweat-absorbing quick-drying fabric of claim 11, wherein the hydrophobic patterns are arranged in an interlocking manner.

15. The method for preparing a unilateral sweat-absorbing quick-drying fabric of claim 11, wherein the hydrophobic patterns are arranged in a matrix manner.

16. The method for preparing a unilateral sweat-absorbing quick-drying fabric of claim 11, wherein the hydrophobic patterns occupy 10% to 90% of the inner surface.

17. The method for preparing a unilateral sweat-absorbing quick-drying fabric of claim 11, wherein the hydrophobic patterns occupy 60% to 90% of the inner surface.

18. The method for preparing a unilateral sweat-absorbing quick-drying fabric of claim 11, wherein the hydrophobic patterns occupy 20% to 60% of the inner surface.

19. The method for preparing a unilateral sweat-absorbing quick-drying fabric of claim 11, wherein the hydrophobic patterns include material selected from the group consisting of fluorocarbon, hydrocarbon, silicone, and hydrophobic polymer.

20. The method for preparing a unilateral sweat-absorbing quick-drying fabric of claim 11, wherein the fiber material is nylon fiber, polyester fiber, aromatic aromide fiber, rayon fiber, bamboo fiber, polylactic acid fiber, or tencel fiber.
